(19) United States
(12) Patent Application Publication
(10) Pub. No.: US 2015/0292470 A1
(43) Pub. Date: Oct. 15, 2015

(54) Apparatus and Method for Harvesting Renewable Energy

(71) Applicant: Yu-Li Sun, Singapore (SG)

(72) Inventor: Yu-Li Sun, Singapore (SG)

(21) Appl. No.: 14/404,282

(22) PCT Filed: Jun. 1, 2012
(86) PCT No.: PCT/SG2012/000198

§ 371 Date: Nov. 26, 2014

(51) Int. Cl. F03B 13/12; F03D 9/00

(52) U.S. Cl. CPC F03B 13/12; F03D 9/008

(57) ABSTRACT

This invention relates to an installation for harvesting renewable energy. The installation includes a first part, a second part and a harvesting means. The first part includes a first harvest point, a weight element and a first connecting element while the second part includes a second harvest point and a second connecting element. The harvesting means is connectable between the first harvest point and the second harvest point. The first connecting element and the second connecting element are freely connectable to each other to allow the first part and the second part to move relative to each other in response to renewable energy impacted on the installation, translating kinetic energy to the harvesting means.

### FIELD OF THE INVENTION

This invention relates to an installation for harvesting renewable energy. More particularly, this invention relates to an installation that is easy to install and maintain. Still more particularly, this invention relates to a configuration that can be implemented in installations for harvesting wind, wave and/or tidal energy.

### PRIOR ART

Driven by high oil prices and/or increasing government support in incentives for driving the use of renewable energy, those skilled in the art are striving to invent ways of scavenging natural resources such as wind, waves, sunlight and etc which are perpetually available.

One type of installation for harvesting energy of sea waves is provided in US publication number US 2007/0158950 A1 (published on 12 Jul. 2007). In this installation, the energy of sea waves is converted to mechanical power after impacting and moving a special panel. The mechanical power is then converted into electrical energy via a complex hydraulic system which is submerged in the water. This is undesirable as maintenance work would be costly and difficult to be carried out since the critical part of the installation which is the complex hydraulic system is submerged in the water. Further, this installation can only be used for harvesting energy of sea waves.

Another type of installation for harvesting energy of sea waves is provided in U.S. Pat. No. 6,857,266 granted on 22 Feb. 2005. In this installation, a point absorber wave energy converter is implemented which comprises at least two buoys floating which are linked together by one or more suspended bodies. Relative movements between the at least two buoys in response to passing waves effects an energy transfer to the one or more suspended bodies. Similar to US publication number US 2007/0158950 A1, this is a complex system and is costly to build and install. See specifically FIGS. 3-6 of U.S. Pat. No. 6,857,266. Again, this installation can only be used for harvesting energy of sea waves.

A common type of installation for harvesting wind energy is the use of wind turbine. The most common type is a wind turbine as shown in US publication number US 2007/0243063 A1 (published on 18 Oct. 2007). Such installations are typically very large and tall and are hence costly. Further, as shown in FIG. 7 of US publication number US 2007/0243063 A1, a special service vessel is required when doing maintenance work on the installation.

Thus, those skilled in the art are constantly striving to design an improved method and apparatus that can be used for harvesting different types of renewable energy that is cost effective to build and install, and easy to maintain.

### SUMMARY OF THE INVENTION

The above and other problems are solved and an advance in the art is made by an installation for harvesting energy in accordance with this invention. A first advantage of an installation in accordance with this invention is that the installation can be easily transported and installed. A second advantage of an installation in accordance with this invention is that the installation can be used for harvesting different types of renewable energy. A third advantage of an installation in accordance with this invention is that the installation is easy to maintain which in turn translate to cost savings.

In accordance with embodiments of this invention, an installation for harvesting energy is provided as follows. The installation comprises a first part having a first harvest point, a weight element and a first connecting element, a second part having a second harvest point and a second connecting element, and a harvesting means connectable between the first harvest point and the second harvest point. The first connecting element and second connecting element are freely connectable to each other, thereby allowing the first part and second part to move relative to each other, translating kinetic energy between the first harvest point and second harvest point to the harvesting means. In accordance with some of these embodiments, the weight element is of a certain amount of mass to drive the first connecting element to the second connecting element to maintain connection. Further, the first connecting element has a rounded bottom and the second connecting element is formed of a bowl like structure configured to receive the first connecting element.

In accordance with embodiments with this invention, the first connecting element extends from the weight element and the first harvest point is located at a point of a perimeter defined by the weight element. Preferably, the first connecting element extends out from a central axis of the weight element. In accordance with some of these embodiments, the second part further comprises a floatable platform defining a perimeter and an upright between the floatable platform and the second connecting element. The second harvest point is located at a point of said perimeter. The bowl like structure of the second connecting element is adapted to allow several degrees of freedom of movement for the first connecting element such that, in use, the first part and second part move relative to one another in response to wave movements, translating lateral movement between the first harvest point and the second harvest point. In accordance with some of these embodiments, the installation further comprises N first harvest points distributed along the perimeter of the weight element, N second harvest points distributed along the perimeter of the floatable platform, and N harvesting means, wherein N is equal to or greater than 2. In accordance with some of these embodiments, the N first harvest points is evenly distributed along the perimeter of the weight element and the N second harvest points is evenly distributed along the perimeter of the floatable platform. Preferably, the floatable platform is configured to certain dimension with certain buoyancy to prevent from installation from toppling into the water.

In accordance with embodiments with this invention, the first part may further comprise an upright extending from the first connecting element and a bracket secured to the upright wherein the first harvest point is located on the bracket. Preferably, the bracket is secured proximate a tip of said upright. The second part may further comprise a floatable platform defining a perimeter. The floatable platform has an indentation to receive the bowl like structure of the second connecting element, wherein the second harvest point is located at a point of the perimeter of the floatable platform. In accordance to some of these embodiments, the bowl like structure of the second connecting element is adapted to allow several degrees of freedom movement for the first connecting element such that, in use, the first part and second part are allowed to move relative to one another in response to wave movements, translating lateral movement between the first harvest point and second harvest point. In accordance to some of these embodiments, the installation may include N first harvest points about the bracket, N second harvest points distributed along the perimeter of the floatable platform, and N harvesting means, wherein N is equal to or greater than 2. The N first harvest points are evenly distributed about the bracket and the N second harvest points is evenly distributed along the perimeter of the floatable platform. In accordance to some of these embodiments, the floatable platform is configured to certain dimension with certain buoyancy to prevent the installation from toppling into the water.

In accordance with embodiments with this invention, the first part may further comprise a sail element and an extension connecting the sail to the first connecting element. The sail element includes a frame having a top bar, a bottom bar and a vertical bar, and a sail secured to the frame, wherein an end of the top bar is connected to the extension. The second part may further comprise an upright having a top end and a bottom end, wherein the second connecting element extends from the top end of the upright. Preferably, the bottom end of the upright is anchored to earth. In accordance to some of these embodiments, the second part may further comprise a weight element of certain mass for said second part to support said first part. Preferably, the first harvest point is located at an end of the bottom bar of the frame and the second harvest point is located proximate bottom end of the upright. In accordance to some of these embodiments, the installation may further comprise a number of frames. Preferably, each of the frames is evenly distributed about the upright to provide a balanced wind turbine.

### BRIEF DESCRIPTION OF THE DRAWINGS

The above and other features and advantages in accordance with this invention are described in the following detailed description and are shown in the following drawings:

FIG. 1a illustrating a side view of an installation 100 for harvesting renewable energy in accordance with an embodiment of this invention;

FIG. 1b illustrating an exploded view of the installation 100 for harvesting renewable energy in accordance with an embodiment of this invention;

FIG. 2 illustrating a top view of the installation 100 for harvesting renewable energy in accordance with an embodiment of this invention;

FIG. 3 illustrating a part cut away view of a joint of the installation 100 for harvesting renewable energy in accordance with an embodiment of this invention;

FIG. 4 illustrating a side view the installation 100 for harvesting renewable energy in response to wave movement in accordance with an embodiment of this invention;

FIG. 5a illustrating a side view another installation 200 for harvesting renewable energy in accordance with an embodiment of this invention;

FIG. 5b illustrating an exploded view of the installation 200 for harvesting renewable energy in accordance with an embodiment of this invention;

FIG. 6 illustrating another side view of the installation 200 for harvesting renewable energy in accordance with an embodiment of this invention;

FIG. 7 illustrating a top view of the installation 200 for harvesting renewable energy in accordance with an embodiment of this invention;

FIG. 8 illustrating a side view the another installation 200 for harvesting renewable energy in response to wave movement in accordance with an embodiment of this invention;

FIG. 9a illustrating a side view yet another installation 300 for harvesting renewable energy in accordance with an embodiment of this invention;

FIG. 9b illustrating an exploded view of the installation 300 for harvesting renewable energy in accordance with an embodiment of this invention;

FIG. 10 illustrating a part cut away view of a joint of the installation 300 for harvesting renewable energy in accordance with an embodiment of this invention;

FIG. 11 illustrating a cross sectional view along the line of A-A in FIG. 9 in accordance with an embodiment of this invention;

FIG. 12 illustrating a connection between the first and second connecting element in accordance with an embodiment of this invention; and

FIG. 13 illustrating another connection between the first and second connecting element in accordance with an embodiment of this invention.

### DETAILED DESCRIPTION

This invention relates to an installation for harvesting renewable energy. More particularly, this invention relates to an installation that is easy to install and maintain. Still more particularly, this invention relates to a configuration that can be implemented in installations for harvesting wind, wave and/or tidal energy.

The invention is hinged on utilizing the confluence points of two gigantic natural forces, namely, Gravity of Earth and Celestial Mechanism to harvest renewable energy. In this invention, the two natural forces meet at two concretized physical points and from there, expands to an installation having a Gravity of Earth Device (i.e. a first part) and a Celestial Mechanism Device (i.e. a second part). Both devices act concertedly in taming the natural forces for harvesting energy.

This invention relates to an installation that includes a first part, a second part and a harvesting means. The first part includes a first connecting element and a first harvest point and a weight element while the second part includes a second connecting element and a second harvest point.

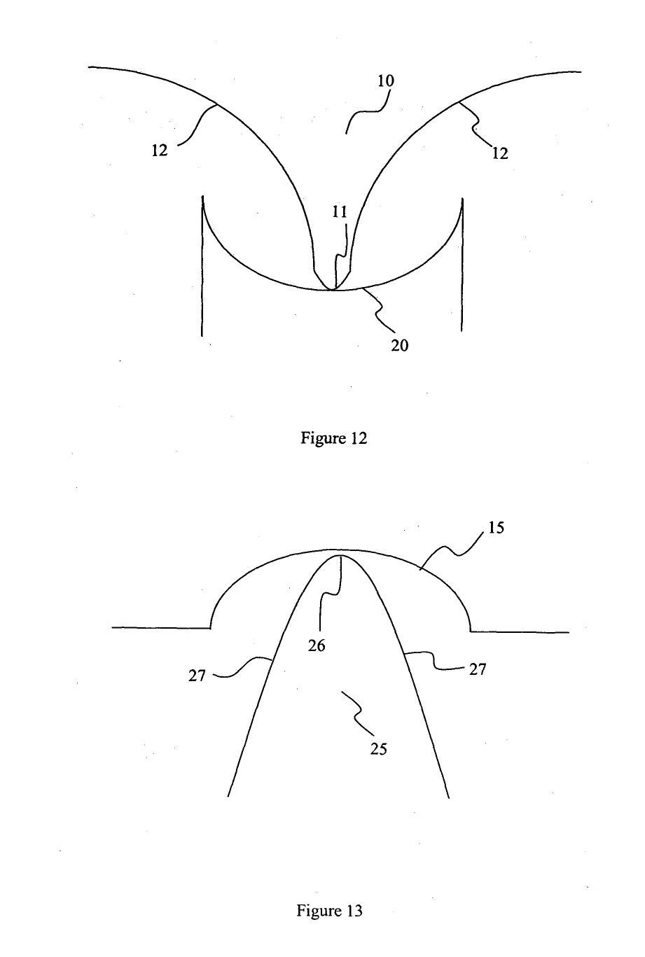

FIG. 12 illustrates that the first connecting element 10 has rounded bottom 11 and a surface 12 tapered towards a rounded bottom while the second connecting element 20 is in a shape of a bowl, configured to receive first connecting element. The first part and the second part are freely connected together by the first and second connecting elements. In particular, first connecting element and second connecting elements maintain connection due to the weight element of the first part having a certain amount of mass to drive the first connecting element towards second connecting element. This means that first connecting element and second connecting element are not fixedly connected to each other. One skilled in the art will recognize that the first part and second part are interchangeable. For example, as shown in FIG. 13, the second connecting element 25 may have rounded tip 26 with a surface 27 tapered towards the rounded tip while the first connecting element 15 is in a shape of a bowl. Both first connecting element and second connecting element can maintain connection due to a weight element having a certain amount of mass to drive the first connecting element towards second connecting element and the exact configuration is left as a design choice for those skilled in the art.

The first part may be defined as a re-active part being affected by earth gravitational pull. Alternatively, the first part may be anchored directly to earth. The second part may be defined as an active part being caused to move by forces of nature such as wind, wave and etc. One skilled in the art will recognize that the first part and second part are interchangeable in their function and hence, the second part may also be defined as the active part while the first part is defined as the re-active part without departing from the invention.

First part and second part are different in mass. The first part and second part will respond concertedly in response to renewable energy such as wind, wave or tidal impacting on the installation. In particular, the first part and the second part are caused to move relative to one another in response to renewable energy impacting on the installation. The harvesting means is connected between the first harvest point and second harvest point to harvest energy produced due to relative movement between the first part and second part in response to renewable energy such as wind or wave impacted on the installation. One such energy produced by the relative movement between the first part and the second part is kinetic energy. The harvesting means is any systems that can be used for converting kinetic energy to electricity such as a hydraulic system, a pneumatic system, a mechanical system, a piezoelectric system or an electrical system. Some exemplary embodiments to this invention will be described below.

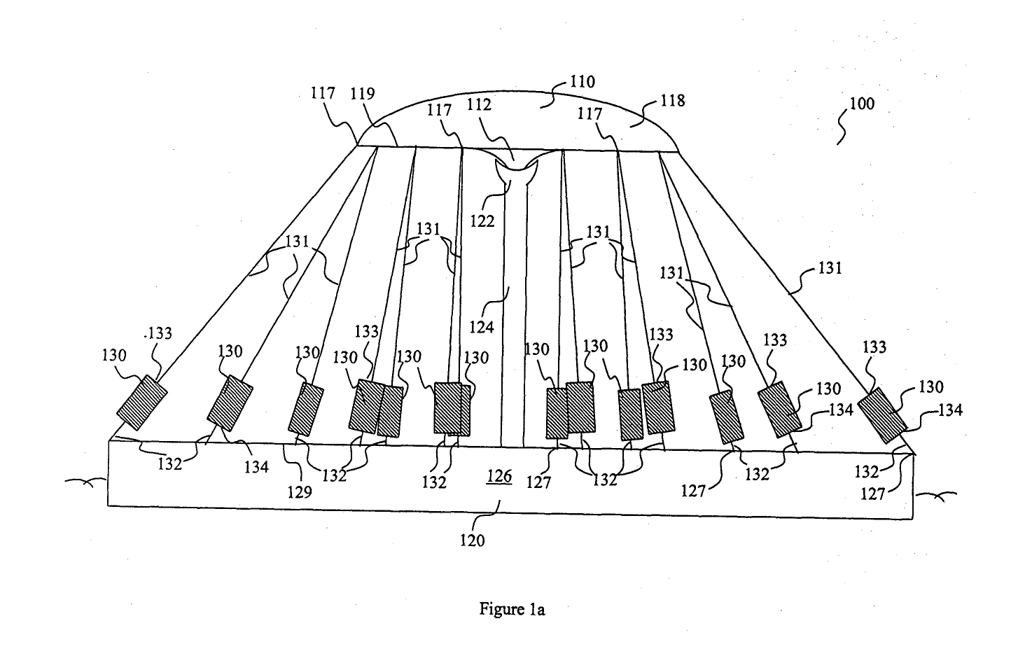

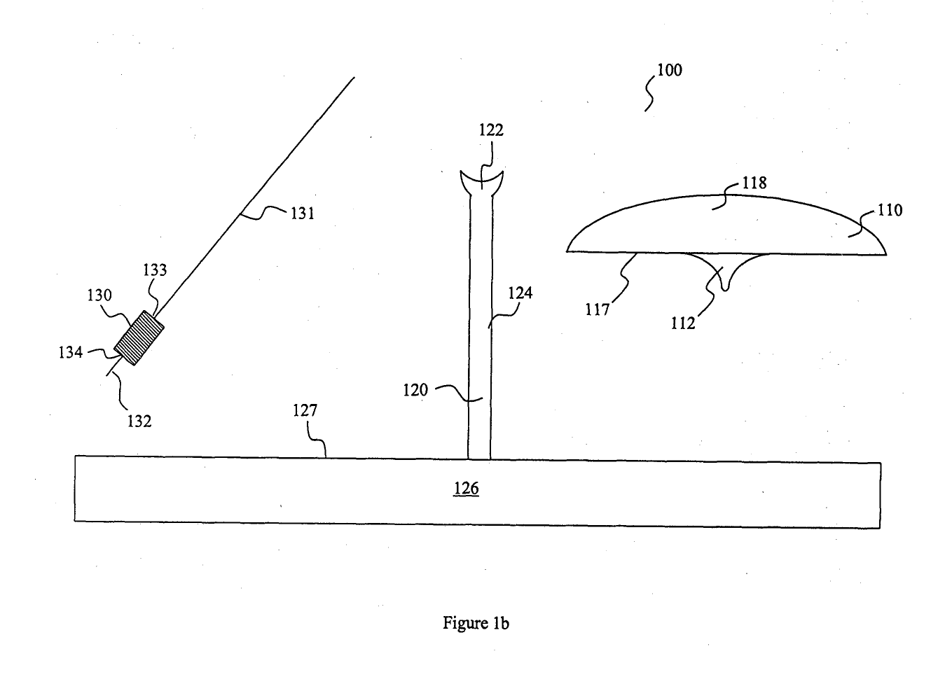

FIGS. 1a, 1b and 3-4 show an embodiment of an installation 100 for harvesting renewable energy in accordance with an embodiment of this invention. Installation 100 comprises a first part 110, a second part 120 and a harvesting means 130. The first part 110 of installation 100 comprises a first connecting element 112, at least one first harvest point 117 and a weight element 118. The second part 120 of installation 100 includes a second connecting element 122, at least one second harvest point 127, a floatable platform 126 and an upright 124 connecting floatable platform 126 to second connecting element 122.

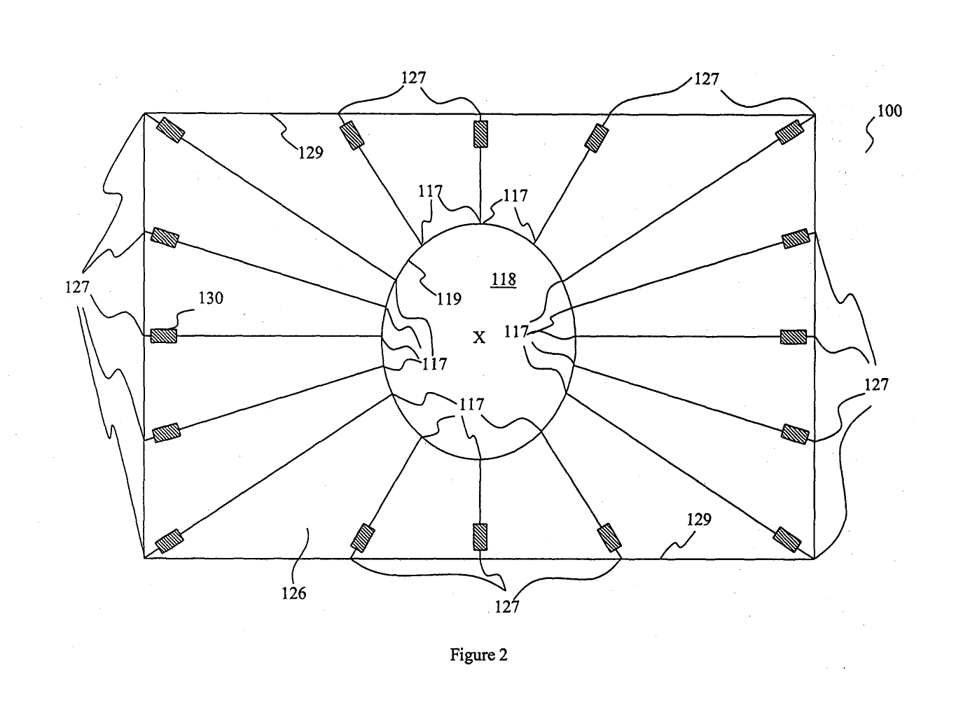

First connecting element 112 protrudes from a central axis, X, as shown in FIG. 2 of weight element 118. This allows the first part 110 to balance itself when placed onto the second connecting element 122. One skilled in the art will recognize that weight element 118 may also be a separate structure that is directly connected to first connecting element without departing from the invention. Further, although weight element 118 is shown in FIGS. 1 and 2 as having a circular shape, other geometric shapes may also be implemented and the exact shape is left as a design choice to the skilled in the art. Still further, although floatable platform 126 is shown in FIG. 2 as having a rectangular shape, other geometric shapes may also be implemented and the exact shape is left as a design choice to the skilled in the art.

As shown in FIG. 2, the first harvest points 117 are distributed along the perimeter 119 of weight element 118 while the second harvest points 127 are distributed along the perimeter 129 of floatable platform 126. Each of the N harvesting means 130 is connected between each pair of first and second harvest points 117 and 127 by wires 131 and 132. As shown in FIG. 2, N is equal to 16. The first harvest points 117 are evenly distributed along the perimeter 119 of weight element 118 while the second harvest points 127 are distributed along the perimeter 129 of floatable platform 126 such that when installation 100 is not subjected to wave or tidal movements, the tension is evenly distributed between each of the N harvesting means. One skilled in the art will recognize that any number of harvesting means may be used and the number of harvesting means is left as a design choice to those skilled in the art.

Harvesting means 130 is any systems that can be used for converting kinetic energy to electricity such as a hydraulic system, a pneumatic system, a mechanical system, a′ piezoelectric system or an electrical system. Although harvesting means 130 is shown as connected to second harvest point 127 by wire 132, one skilled in the art will recognise that harvesting means 130 may also be directly connected to second harvest point 127 without wire 132 and the exact configuration is left as a design choice for the skilled in the art. Further, harvesting means 130 is also configured to control the tension of the wires 131 and 132 in order to secure the first part 110 to second part 120.

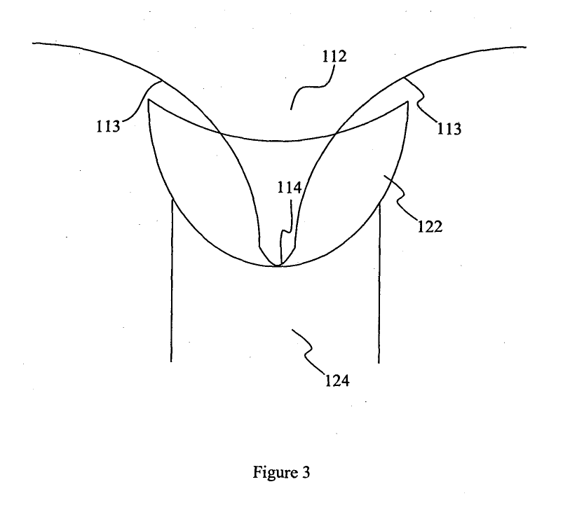

FIG. 3 shows a joint between first connecting element 112 and second connecting element 122 with the second connecting element 122 being a part cutaway view. The first connecting element 112 is a protrusion from weight element 118 having surface 113 tapered towards a rounded bottom 114. The second connecting element 122 is in a shape of a bowl, configured to receive first connecting element 112 as shown in FIG. 3. The first and second connecting elements 112 and 122 are freely connectable to each other. First connecting element 112 and second connecting element 122 maintain connection due to weight element 118 having a certain amount of mass to drive the first connecting element 112 towards second connecting element 122. This means that first connecting element 112 and second connecting element 122 are not fixedly secured to each other. This allows easy transportation of installation 100. Further, the bowl like structure of second connecting element 122 is configured to allow several degrees of freedom of movement for first connecting element 112 such that, in use, first part 110 and second part 120 are allowed to move relative to one another in response to wave movements, translating lateral movement of harvesting means 130 between the first harvest points 117 and second harvest points 127. One skilled in the art will recognize that although second connecting element 122 is shown as extending out from the top of upright 124, second connecting element may also be configured as an indentation at the top of upright 124 to form the bowl like structure without departing from the invention.

To assemble installation 100, a first open end of wire 131 is connected to first part 110. Specifically, the first end of each of the N wires 131 is connected to one of the first harvest points 117. First part 110 is then raised and adjusted to a location such that the rounded bottom 114 of the first connecting element 112 is over bowl like structure of the second connecting element 122. First part 110 is lowered so that first connecting element 112 rest on second connecting element 122. The second end of each of the N wires 131 is then connected to a first end 133 of one of the N harvesting means 130 while a second end 134 of the harvesting means 130 is connected directly to one of the second harvest points 127 or via wire 132. As shown in FIG. 2, N is equal to 14. However, one skilled in the art will recognize that any number of harvesting means 130 may be used and the number of harvesting means 130 is left as a design choice to those skilled in the art.

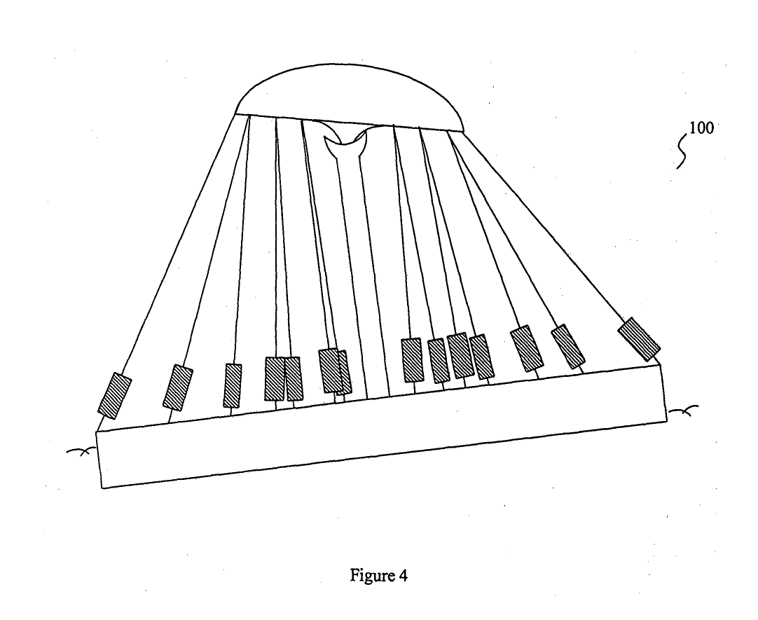

FIG. 4 shows the movement of installation 100 in response to wave movements. Floatable platform moves in response to wave movements. As weight element 118 is of certain mass, gravitational pull of weight element 118 increases the resistance of first part 110 to change its state of motion in respect to second part 120. This causes first part 110 and second part 120 to move relative to one another in response to wave movements. Due to relative movement of first part 110 and second part 120, the first and second harvest points 117 and 127 are caused to move apart or towards each other. These movements translate to kinetic energy to the harvesting means 130.

Floatable platform is configured to certain dimension with certain buoyancy such that, in use, movement of floatable platform in response to wave movements is able to prevent the installation 100 from toppling into the water.

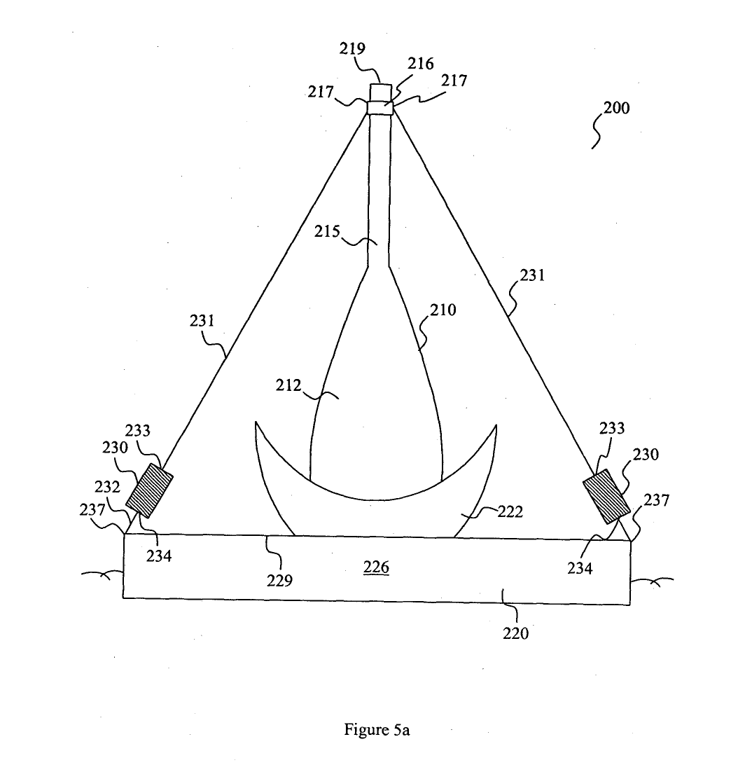

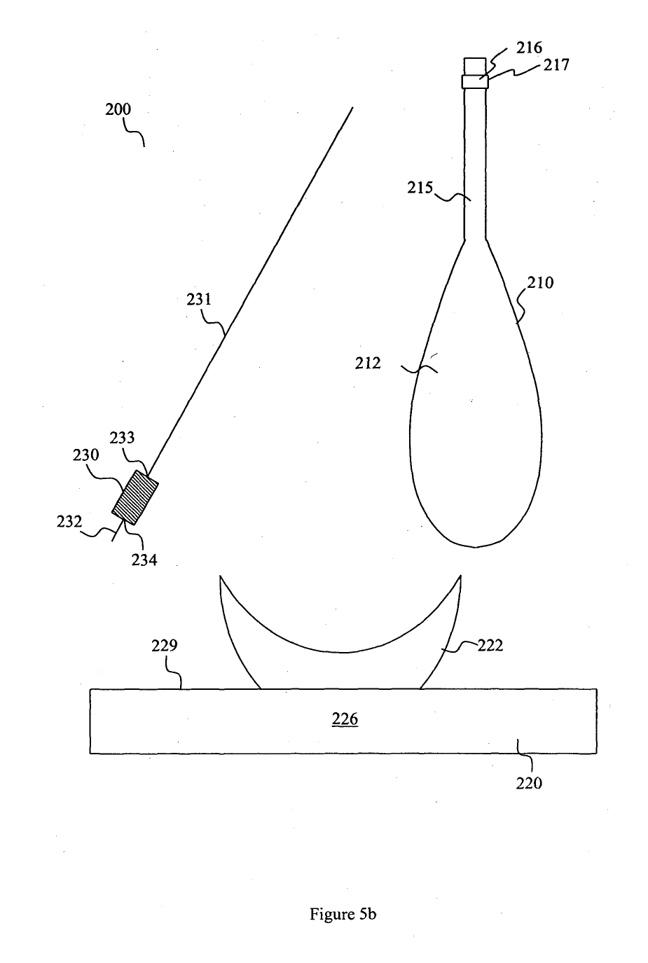

FIGS. 5a, 5b and 6-8 show an embodiment of an installation 200 for harvesting renewable energy in accordance with another embodiment of this invention. Installation 200 comprises a first part 210, a second part 220 and a harvesting means 230. The first part 210 of installation 200 includes a first connecting element 212, at least one first harvest point 217 and an upright 215. The second part 220 of installation 200 includes a second connecting element 222, at least one second harvest point 237 and a floatable platform 226.

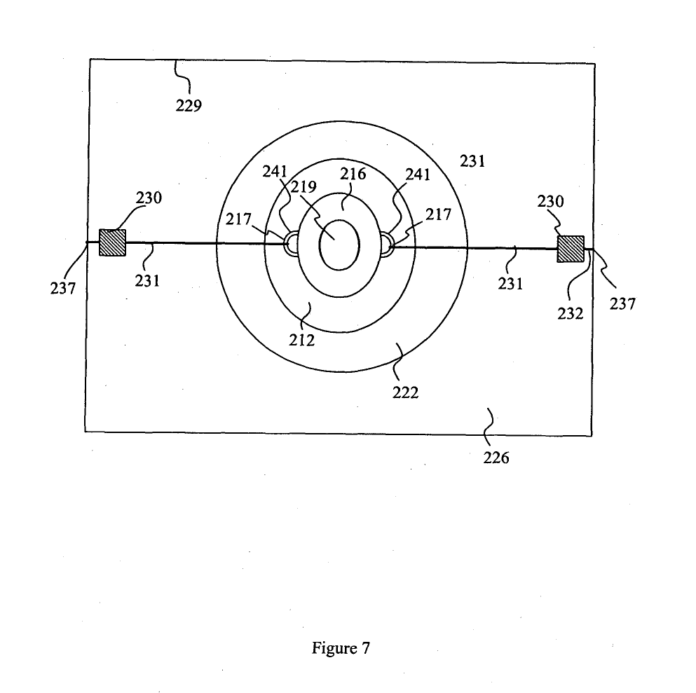

FIG. 7 shows a view from the top of installation 200. The first harvest points 217 are distributed about a bracket 216. More specifically, each of the first harvest points 217 is provided at a mounting member 241 configured to receive wire 231. Bracket 216 is fixedly secured to upright 215. To obtain the best efficiency of harvesting energy, bracket 216 is typically located at the tip 219 of upright 215 or proximate tip 219. The second harvest points 237 are distributed along the perimeter 229 of floatable platform 226. Although floatable platform 226 is shown in FIG. 7 as having a rectangular shape, other geometric shapes may also be implemented and the exact shape is left as a design choice to the skilled in the art.

Each of the N harvesting means 230 is connected between each pair of first and second harvest points 217 and 237 by wires 231 and 232. As shown in FIG. 5, N is equal to 2. However, one skilled in the art will recognize that any number of harvesting means may be used and the number of harvesting means is left as a design choice to those skilled in the art. The first harvest points 217 are evenly distributed about the bracket 216 while the second harvest points 237 are evenly distributed along the perimeter 229 of floatable platform 226, such that when installation 200 is not subjected to wave or tidal movements, the tension is evenly distributed between each of the N harvesting means.

Harvesting means 230 is any systems that can be used for converting kinetic energy to electricity such as a hydraulic system, a pneumatic system, a mechanical system, a piezoelectric system or an electrical system. Although harvesting means 230 is shown as connected to second harvest point 237 by wire 232, one skilled in the art will recognise that harvesting means 230 may also be directly connected to second harvest point 237 without wire 232 and the exact configuration is left as a design choice for the skilled in the art.

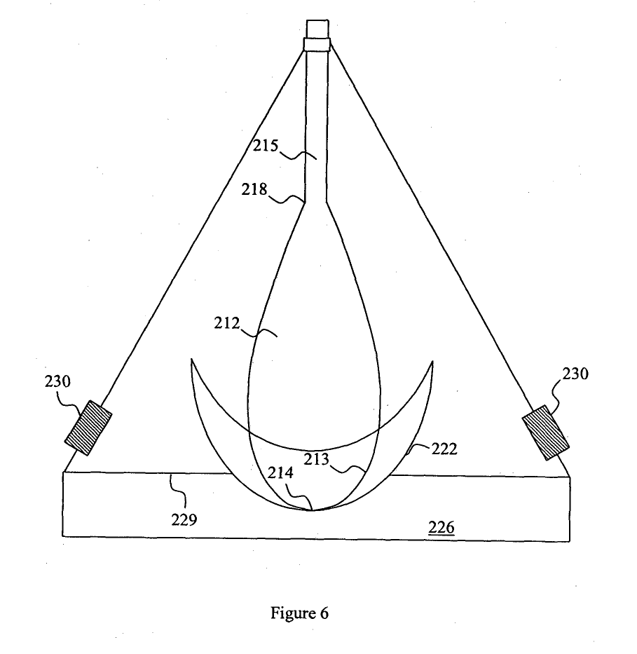

FIG. 6 shows a joint between first connecting element 212 and second connecting element 222 with the second connecting element 222 being a part cutaway view. First connecting element 212 has a surface 213 tapered towards a first end having a rounded bottom 214 and is of certain mass. Upright 215 extends from a second end 218 of first connecting element 212. One skilled in the art will recognize that upright 215 may also be a separate structure that is directly connected to first connecting element 212 without departing from the invention.

Second connecting element 222 is in a shape of a bowl, configured to receive first connecting element 212 as shown in FIG. 6. Platform 226 has an indentation to receive the bowl like structure of second connecting element 222. First connecting element 212 and second connecting element 222 are freely connectable to each other. First connecting element 212 and second connecting element 222 maintain connection due to first connecting element having a certain amount of mass to drive the first connecting element 212 towards second connecting element 222. This means that first connecting element 212 and second connecting element 222 are not fixedly secured to each other. This allows easy transportation of installation 200. Further, the bowl like structure of second connecting element 222 is configured to allow several degrees of freedom of movement for first connecting element 212 such that, in use, first part 210 and second part 220 are allowed to move relative to one another in response to wave movements, translating lateral movement of harvesting means 230 between the first harvest points 217 and second harvest points 237. One skilled in the art will recognize that although second connecting element 222 is shown as extending out from the platform 226, second connecting element 222 may also be configured as an indentation on the top surface of platform 226 to form the bowl like structure without departing from the invention.

To assemble installation 200, a first open end of wire 231 is connected to first part 210. Specifically, a first open end of each of the N wire 231 is connected to one of the mounting members 241. First part 210 is then raised and adjusted to a location such that first connecting element 212 is over second connecting element 222. First part 210 is lowered so that first connecting element 212 rest on the inner surface of second connecting element 222. The second end of each of N wire 231 is then connected to a first end 233 of one of N harvesting means 230 while a second end 234 of the harvesting means is connected directly to one of the second harvest points 237 or via wire 232.

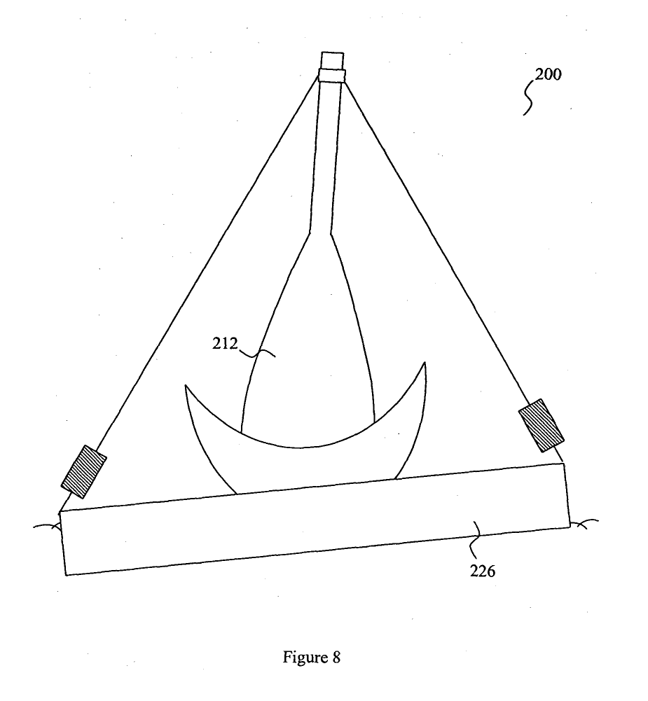

FIG. 8 shows the movement of installation 200 in response to wave movements. Floatable platform 226 moves in response to wave movements. As first connecting element 212 is of a certain mass, gravitational pull of first connecting element 212 increases the resistance of first part 210 to change its state of motion in respect to second part 220. In particular, a larger mass is located at or proximate the first end 214 of first connecting element 212. This causes first part 210 and second part 220 to move relative to one another in response to wave movements. Due to relative movement of first part 210 and second part 220, the first and second harvest points 217 and 237 are caused to move apart or towards each other. These movements translate to kinetic energy to the harvesting means 130.

Floatable platform is configured to certain dimension with certain buoyancy such that, in use, movement of floatable platform in response to wave movements is able to prevent the installation 200 from toppling into the water.

In installations 100 and 200, the harvesting means are located near the floatable platform. This allows maintenance works on the harvesting means to be safely carried out.

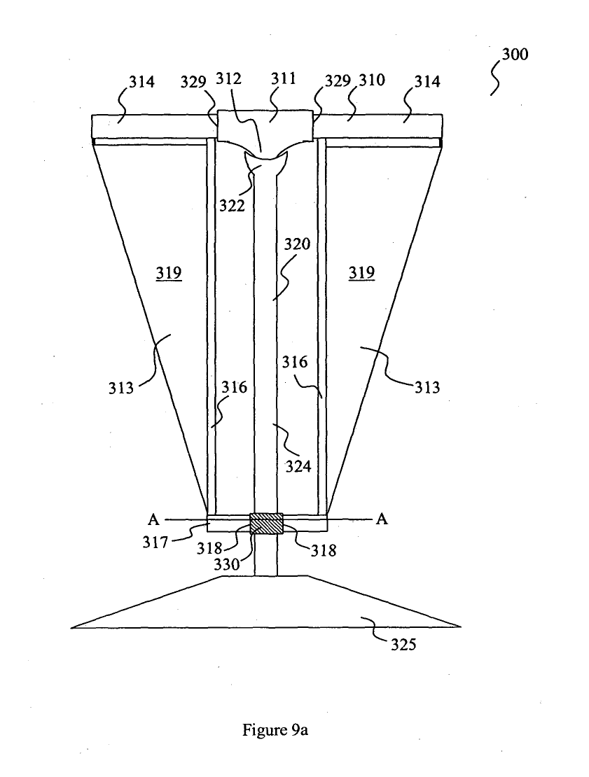

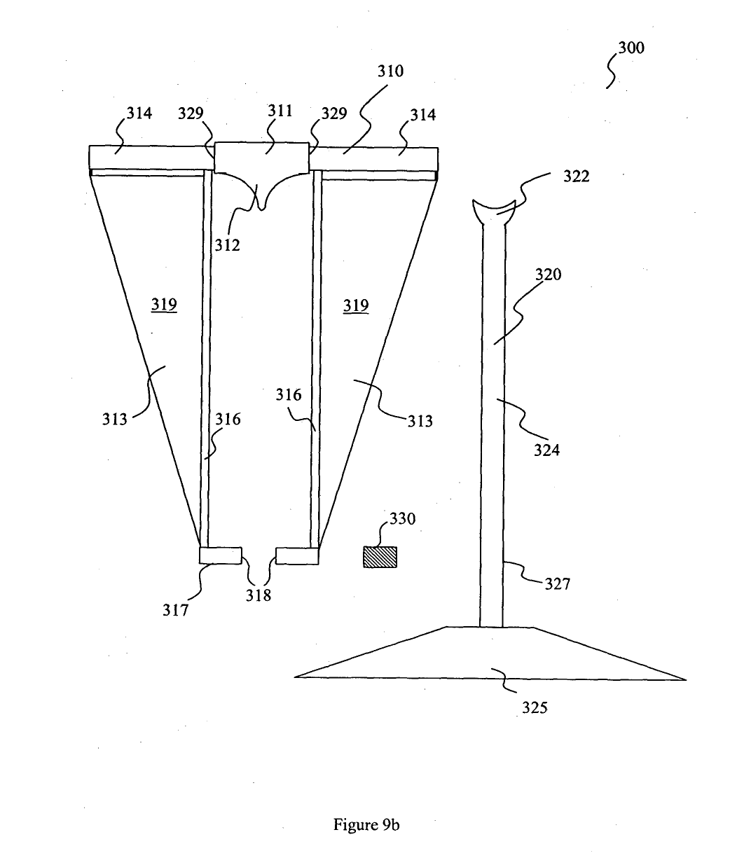

FIGS. 9a, 9b and 10-11 show another embodiment of an installation 300 for harvesting renewable energy in accordance with an embodiment of this invention. Installation 300 comprises a first part 310, a second part 320 and a harvesting means 330. The first part 310 of installation 300 includes a first connecting element 312 and at least one sail element 313. The second part 320 of installation 300 includes a second connecting element 322, at least one first harvest point 327 and an upright 324.

Second connecting element 322 extends from a top end of upright 324. Upright 324 is connected to a plate 325. One skilled in the art will recognize that plate 325 may be any geometric shape as long as plate 325 contains enough mass in order for second part 320 to support first part 310. Alternatively, upright 324 may be anchored directly to earth.

Sail element 313 includes N frames having a top bar 314, a vertical bar 316 and a bottom bar 317. Vertical bar 316 extends between top bar 314 and bottom bar 317. Each of the frames holds a sail 319. An extension 311 is provided between first connecting element 312 and an end 329 of top bar 314. As shown in FIGS. 9a and 9b, N is equal to 2. However, one skilled in the art will recognize that any number of frames may be used and the choice of number of frames is left as a design choice to those skilled in the art as long as the frames are evenly distributed about the upright to provide a balanced wind turbine. Further, one skilled in the art will also recognize that sail element 313 is provided for catching wind energy in order to cause relative movements between first part 310 and second part 320. In particular for this embodiment, sail element 313 is provided to rotate first part 310 about second part 320 in response to passing wind. Hence, other configurations of sail element 313 to catch passing wind may be used and the exact configuration is left as a design choice to those skilled in the art.

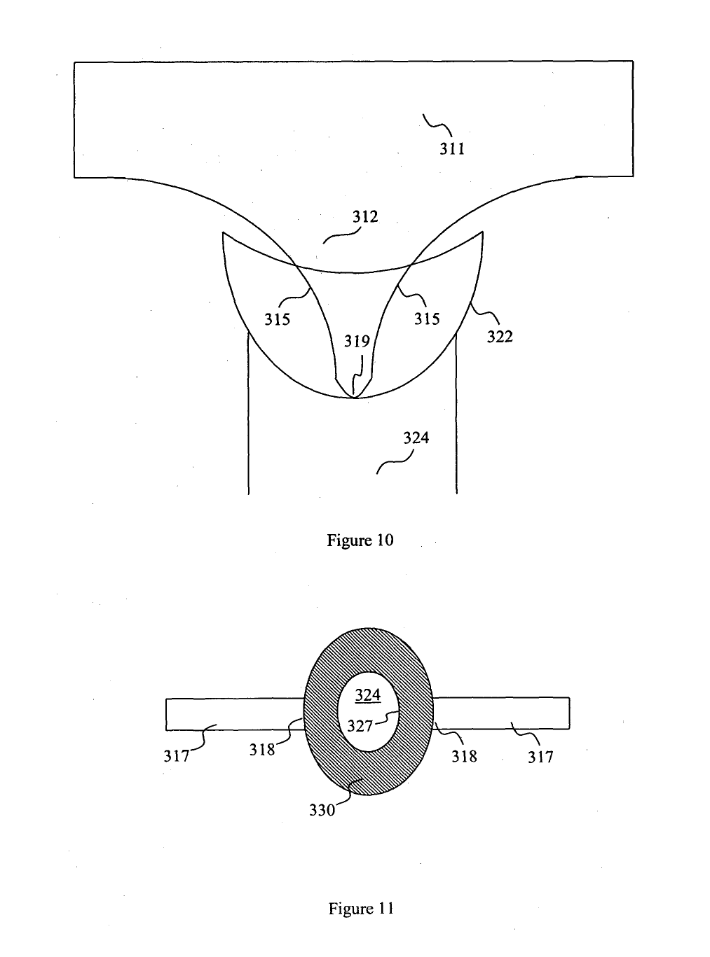

FIG. 10 shows a joint between second connecting element 322 and first connecting element 312 with the second connecting element 322 being a part cutaway view. In this embodiment, first connecting element 312 extends from extension 311. First connecting element 312 has a surface 315 tapered towards an end having a rounded bottom 319. The second connecting element 322 is shape of a bowl configured to receive first connecting element 312 as shown in FIG. 10. Second connecting element 322 and first connecting element 312 are freely connectable to each other. Second connecting element 322 and first connecting element 312 maintain connection due to the frames and/or extension 311 having a certain amount of mass to drive the first connecting element 312 towards second connecting element 322. This means that second connecting element 322 and first connecting element 312 are not fixedly secured to each other. This allows easy transportation and installation of installation 300 which will be described below. Further, bowl like structure of second connecting element 322 and the first connecting element 312 are configured such that, in use, first part 310 and second part 320 are allowed to move relative to one another in response to wind. In particular, first part 310 rotates about second part 320 in order for harvesting means to harvest kinetic energy. One skilled in the art will recognize that although second connecting element 322 is shown as extending out from the top of upright 324, second connecting element 322 may also be configured as an indentation at the top of upright 324 to form the bowl like structure without departing from the invention.

FIG. 11 shows a cross sectional view along the line A-A in FIG. 9. The first harvest point 318 is located at an end of bottom bar 317 while the second harvest point 327 is located on the surface of upright 324. A harvesting means 330 is connected between the first harvest points and the second harvest point.

Harvesting means 330 is any systems that can be used for converting kinetic energy to electricity such as a hydraulic system, a pneumatic system, a mechanical system, a piezoelectric system or an electrical system.

To assemble installation 300, first part 310 is raised and adjusted to a position such that first connecting element 312 is over second connecting element 322. First part 310 is then lowered so that first connecting element 312 rests on second connecting element 322. The harvesting means 330 is connected to the second harvest point 327. Each of the first harvest points 318 is then connected to the harvesting means 330.

In installation 300, the harvesting means 330 is located near ground level. This allows maintenance works on the harvesting means to be safely carried out.

The above is a description of exemplary embodiments of an installation for harvesting renewable energy in accordance with this invention. It is foreseeable that those skilled in the art can and will design alternative systems based on this disclosure that infringe upon this invention as set forth in the following claims.

1. An installation for harvesting renewable energy comprising:
a first part having a first harvest point, a weight element and a first connecting element;
a second part having a second harvest point and a second connecting element; and
a harvesting means connectable between said first harvest point and said second harvest point, wherein said first connecting element and said second connecting element are freely connectable to each other, thereby allowing said first part and said second part to move relative to each other in response to renewable energy impacted on said installation, translating kinetic energy to said harvesting means.

2. The installation according to claim 1 wherein said weight element is of a certain amount of mass to drive said first connecting element to said second connecting element to maintain connection.

3. The installation according to claim 1 wherein said first connecting element has a rounded bottom and said second connecting element is formed of a bowl like structure configured to receive said first connecting element.

4. The installation according to claim 3 wherein said first connecting element extends from said weight element and said first harvest point is located at a point of a perimeter defined by said weight element.

5. The installation according to claim 4, wherein said first connecting element extends out from a central axis of said weight element.

6. The installation according to claim 4 wherein said second part further comprises:
a floatable platform defining a perimeter; and
an upright between said floatable platform and said second connecting element, wherein said second harvest point is located at a point of said perimeter.

7. The installation according to claim 6 wherein said bowl like structure of said second connecting element is adapted to allow several degrees of freedom of movement for said first connecting element such that, in use, said first part and said second part move relative to one another in response to wave movements, translating lateral movement between said first harvest point and said second harvest point.

8. The installation according to claim 7 further comprising:
N first harvest points distributed along said perimeter of said weight element;
N second harvest points distributed along said perimeter of said floatable platform; and
N harvesting means, wherein N is equal to or greater than 2.

9. The installation according to claim 8 wherein said N first harvest points is evenly distributed along said perimeter of said weight element and said N second harvest points is evenly distributed along said perimeter of said floatable platform.

10. The installation according to claim 6 wherein said floatable platform is configured to certain dimension with certain buoyancy to prevent said installation from toppling into the water.

11. The installation according to claim 3 wherein said first part further comprises:
an upright extending from said first connecting element,
a bracket secured to said upright, wherein said first harvest point is located on said bracket.

12. The installation according to claim 11 wherein said bracket is secured proximate a tip of said upright.

13. The installation according to claim 11 wherein said second part further comprises:
a floatable platform defining a perimeter, said floatable platform having an indentation to receive said bowl like structure of said second connecting element, wherein said second harvest point is located at a point of said perimeter.

14. The installation according to claim 13 wherein said bowl like structure of said second connecting element is adapted to allow several degrees of freedom movement for said first connecting element such that, in use, said first part and said second part are allowed to move relative to one another in response to wave movements, translating lateral movement between said first harvest point and said second harvest point.

15. The installation according to claim 14 further comprising:
N first harvest points about said bracket;
N second harvest points distributed along said perimeter of said floatable platform; and
N harvesting means, wherein N is equal to or greater than 2.

16. The installation according to claim 15 wherein said N first harvest points is evenly distributed about said bracket and said N second harvest points is evenly distributed along said perimeter of said floatable platform.

17. The installation according to claim 13 wherein said floatable platform is configured to certain dimension with certain buoyancy to prevent said installation from toppling into the water.

18. The installation according to claim 3 wherein said first part further comprises:
a sail element; and
an extension connecting said sail to said first connecting element.

19. The installation according to claim 18 wherein said sail element comprises:
a frame having a top bar, a bottom bar, and a vertical bar; and
a sail secured to said frame, wherein an end of said top bar is connected to said extension.

20. The installation according to claim 19 wherein said second part further comprises:
an upright having a top end and a bottom end, wherein said second connecting element extends from said top end of said upright.

21. The installation according to claim 20 wherein said bottom end of said upright is anchored to earth.

22. The installation according to claim 20 wherein said second part further comprises:
a weight element of certain mass for said second part to support said first part.

23. The installation according to claim 20 wherein said first harvest point is located at an end of said bottom bar of said frame and said second harvest point is located proximate bottom end of said upright.

24. The installation according to claim 23 further comprising a plurality of frames.

25. The installation according to claim 24 wherein said plurality of frames is evenly distributed about said upright to provide a balanced wind turbine.
